(19) United States
(12) Patent Application Publication
(10) Pub. No.: US 2008/0040536 A1
(43) Pub. Date: Feb. 14, 2008

(54) METHOD AND APPARATUS FOR DEVICE TO REQUEST AND OPERATE AN EXTERNAL BUFFER PROVIDED FROM THE HOST

(76) Inventors: Jih-Liang Juang, I-Lan Hsien (TW); Pao-Ching Tseng, Hsinchu County (TW); Cheng-Chieh Lin, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/733,194

(22) Filed: Apr. 9, 2007

Related U.S. Application Data
(60) Provisional application No. 60/803,239, filed on May 26, 2006.

(51) Int. Cl. G06F 13/00

(52) U.S. Cl. 711/111

(57) ABSTRACT

A method utilized in an electrical system is proposed. The electrical system includes a device, a host comprising a storage medium, and an interface interconnecting the device and the host. In an example of the proposed method, the device sends a buffer create request to the host. In response to the buffer create request, the host allocates a segment of the storage medium to the device. The device then utilizes the segment as an external buffer.

### CROSS REFERENCE TO RELATED APPLICATIONS

This application claims the benefit of U.S. Provisional Application No. 60/803,239, which was filed on May 26, 2006 and is incorporated herein by reference.

### BACKGROUND

The invention relates to electrical systems, and more particularly, to methods and apparatus for device to request and operate an external buffer provided from the host.

A host, a device, and a mass information source constitute a common electrical system. A first interface interconnects the host and the device. A second interface of the device allows the device to access the mass information source. The host at least comprises a first storage medium that serves as a host buffer; and the device at least comprises a second storage medium that serves as a device buffer. For some circumstances, the second interface is much slower than the first interface, and the capacity of the second storage medium is smaller than that of the first storage medium. Therefore, when the host accesses the mass information source via the device, the overall data transfer rate is mainly limited by the inferior speed of the second interface and the lesser capacity of the second storage medium.

In the early days, Integrated Drive Electronics (IDE) interfaces and Small Computer Systems Interfaces (SCSIs) were the two primary types of standardized interfaces that could be used to realize the aforementioned first interface. Additionally, the device was always designed as a slave-like device while the host served as a master. More specifically, only the host was allowed to actively send requests to the device. The device operated passively according to the requests issued by the host and was not allowed to send requests to the host voluntarily. Under this kind of master-slave relationship, the only way to give the device more device buffer is to increase the capacity of the second storage medium. However, increasing the capacity of the second storage medium inevitably causes the cost of the device to be raised. Apparently, this solution will not be appreciated by the cost-conscious manufacturers.

### SUMMARY

An aspect of an electrical system comprises a device, a host and an interface interconnecting the device and the host, the device can spontaneously send a semantic electrical signal to the host and ask for some specific services.

An aspect of this disclosure provides a method utilized in an electrical system. The electrical system comprises a device, a host comprising a storage medium, and an interface interconnecting the device and the host. In the method, the device first sends a buffer-related request to the host, the buffer-related request corresponding to a segment of the storage medium. In response to the buffer-related request, the host performs processing related to the segment of the storage medium according to the buffer-related request. The segment of the storage medium is allocated to the device as an external buffer.

Another aspect of this disclosure provides a method utilized in an electrical system. The electrical system comprises a device, a host comprising a storage medium, and an interface interconnecting the device and the host. In the method, the host first sends a common purpose host buffer-related (CPHB-related) command to the device. The device then performs processing according to the CPHB-related command.

Yet another aspect of this disclosure provides an electrical system. The electrical system comprises a mass information source, a device, a host, and a first interface. The device comprises a second interface that allows the device to access the mass information source. The first interface interconnects the host and the device. The host comprises a storage medium, a segment of which is allocated to the device as an external buffer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a block diagram of an electrical system according to an embodiment.

FIG. 2 shows an exemplary state chart of the device of FIG. 1 in a buffer-create scenario according to an embodiment.

FIG. 3 shows an exemplary state chart of the device of FIG. 1 in a buffer-fill scenario according to an embodiment.

FIG. 4 shows an exemplary state chart of the device of FIG. 1 in a buffer-read scenario according to an embodiment.

FIG. 5 shows an exemplary state chart of the device of FIG. 1 in a buffer-delete scenario according to an embodiment.

FIG. 6 shows three examples of interaction flow between the host and the device of FIG. 1.

FIG. 7 and FIG. 8 show two examples of interaction flow between an application program (AP) of the host, the host, and the device of FIG. 1.

FIG. 9 shows an example of interaction flow between the host and the device of FIG. 1.

FIG. 10 illustrates field definitions of a frame information structure (FIS) regarding a first protocol provided according to an embodiment of the present invention.

FIG. 11 illustrates an operation code for an ATA READ CPHB command according to the embodiment shown in FIG. 10.

FIG. 12 is a table of a plurality of function modes according to the embodiment shown in FIG. 10.

FIG. 13 and FIG. 14 respectively illustrate the corresponding FIS format and the corresponding format of response data of a function mode listed in FIG. 12.

FIG. 15 and FIG. 16 respectively illustrate the corresponding FIS format and the corresponding format of response data of another function mode listed in FIG. 12.

FIG. 17 illustrates field definitions of a FIS regarding a second protocol provided according to another embodiment of the present invention.

FIG. 18 is a table of a plurality of function modes according to the embodiment shown in FIG. 17.

FIG. 19 and FIG. 20 respectively illustrate the corresponding FIS format and the corresponding sending format of a function mode listed in FIG. 18.

FIG. 21 and FIG. 22 respectively illustrate the corresponding FIS format and the corresponding sending format of another function mode listed in FIG. 18.

### DETAILED DESCRIPTION

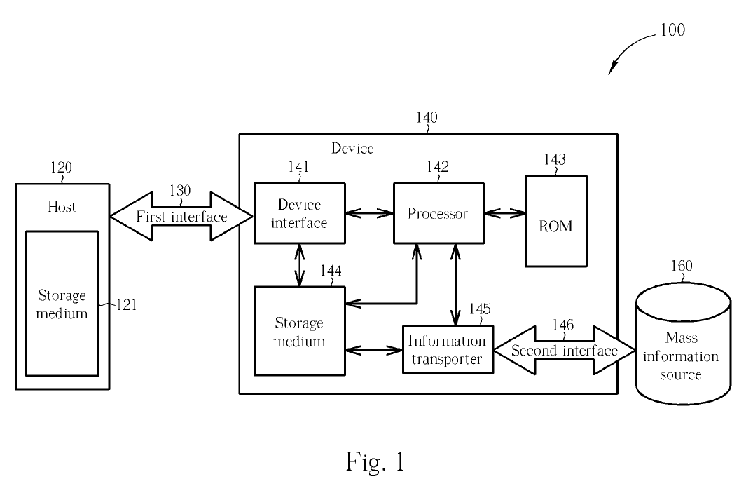

FIG. 1 shows a block diagram of an electrical system 100 according to an embodiment. The electrical system 100 comprises a host 120, a device 140, and a mass information source 160. A first interface 130 interconnects the host 120 and the device 140. A second interface 146 of the device 140 allows the device 140 to access the mass information source 160. The host 120 comprises a storage medium 121 and other components not shown in FIG. 1. The device 140 comprises a device interface 141, a processor 142, a read only memory (ROM) 143, a storage medium 144, an information transporter 145, and the second interface 146. The storage medium 121 serves as a host buffer providing buffer space to the host 120, and the storage medium 144 serves as a device buffer providing buffer space to the device 140. For instance, the host 120 could be a computer or a server; the device 140 could be an optical disc drive; and the mass information source 160 could be an optical disc. Random access memory (RAM) such as dynamic random access memory (DRAM) and static random access memory (SRAM) serves as examples of the storage media 121 and 144.

With the advances of technology, some powerful interfaces are proposed such as Serial Advanced Technology Attachment (SATA) interfaces. In the embodiment shown in FIG. 1, one of the powerful interfaces is used to realize the first interface 130. Through the first interface 130, the device 140 can not only passively respond to requests issued by the host 120, but is also allowed to send requests to the host 120 voluntarily.

Normally, the capacity of the storage medium 121 is relatively larger than that of the storage medium 144. Therefore, if the buffer space provided by the storage medium 144 is insufficient for the device 140, one feasible solution is to allow the device 140 to borrow buffer space from the host 120. In other words, the electrical system 100 has a common purpose host buffer (CPHB) function that allows the host 120 to provide external buffers to the device 140. If the capacity of the storage medium 144 is insufficient for the device 140, the device 140 voluntarily sends a buffer create request, which may specify a required buffer size, to the host 120. In response to the buffer create request issued by the device 140, the host 120 allocates one or more segments of the storage medium 121 to the device 140. The device 140 then utilizes the allocated segments of the storage medium 121 as external buffers. The device 140 may utilize a table to record what is stored in the external buffers. Since both the originally possessed storage medium 144 and the additionally allocated segments of the storage medium 121 can provide buffer space to the device 140, the inferior buffer space problem on the device 140 side is solved. In addition, another advantage is that the overall performance of the host 120 accessing the mass information source 160 via the device 140 can be dramatically increased.

Based on the common purpose host buffer (CPHB) scheme, several functions that allow the device 140 to interact with the host 120 are also disclosed. For example, assume that a buffer-create function of the device 140 is enabled. With the buffer-create function, the device 140 voluntarily borrows buffer space from the host 120. The host 120 can allocate one or more segments of the storage medium 121 to the device 140 as external buffers. The sizes of the allocated segments of the storage medium 121 are either determined by the host 120 or determined by the device 140. Additionally, for each allocated segment of the storage medium 121, the host 120 returns a buffer identity (ID) representing the segment to the device 140.

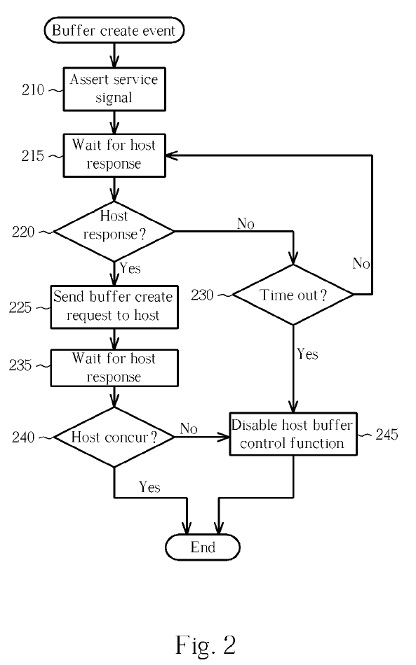

FIG. 2 shows an exemplary state chart of the device 140 performing the aforementioned buffer-create function. In the beginning, a buffer create event occurs. An example of the buffer create event is the device 140 finding the buffer space provided by the storage medium 144 to be insufficient. In response to the buffer create event, the device 140 asserts a service signal on the first interface 130 to request service from the host 120. If a timer expires before the host 120 responds to the asserted service signal, the device 140 simply disables its host buffer control function and ends the state chart. On the other hand, if the host 120 responds to the asserted service signal before the timer expires, the device 140 sends a buffer create request, which may specify a required buffer size, to the host 120. For example, the device 140 sends a packet CREATE_BUF(SIZE) to the host 120 as the buffer create request. The content SIZE included in the packet CREATE_BUF(SIZE) specifies the required buffer size. The device 140 then waits for the host 120 to respond. If the host 120 concurs with the buffer create request, it allocates segment(s) of the storage medium 121 to the device 140 and returns buffer ID(s) of the allocated segment(s) to the device 140. The state chart is then ended and the device 140 can start utilizing the allocated segments as external buffers according to the returned buffer IDs. If, however, the host 120 does not respond to the buffer create request in time or simply rejects to the buffer create request, the device 140 disables its host buffer control function and ends the state chart.

Aside from the buffer-create function illustrated by FIG. 2, there is also a fixed-buffer function. In contrast with the device 140 dynamically borrowing buffer space from the host 120, with the fixed-buffer function the host 120 automatically and fixedly provides segment(s) in the storage medium 121 to the device 140 as external buffer(s). The device 140 is allowed to utilize the external buffers provided by the host 120 whenever required. Under this fixed-buffer scheme, the amount of the segments in the storage medium 121 allocated to the device 140 and the sizes of these segments are fixed. The host 120 may inform the device 140 about the buffer IDs of the allocated segments before the device 140 starts utilizing the allocated segments as external buffers.

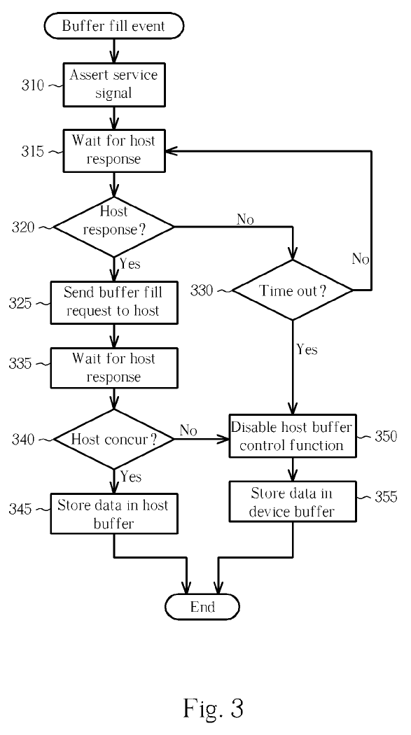

Assume that a buffer-fill function of the device 140 is enabled. With the buffer-fill function, the device 140 fills data into the external buffer provided by the host 120. The buffer ID of a target segment for storing the data, the offset of the target segment, and the length of the data may be specified by the device 140. FIG. 3 shows an exemplary state chart of the device 140 performing the aforementioned buffer-fill function. In the beginning, a buffer fill event occurs. In response to the buffer fill event, the device 140 asserts a service signal on the first interface 130 to request service from the host 120. If a timer expires before the host 120 responds to the asserted service signal, the device 140 simply disables its host buffer control function and stores the data into its own storage medium 144. If, on the other hand, the host 120 responds to the asserted service signal before the timer expires, the device 140 sends a buffer fill request to the host 120. The device 140 then waits for the host 120 to respond. If the host 120 concurs with the buffer fill request, the device 140 sends data to the host 120 and the host 120 stores the data into the storage medium 121 accordingly. The state chart is then ended. If the host 120 does not respond to the buffer fill request in time or simply rejects to the buffer fill request, the device 140 disables its host buffer control function and stores the data into its own storage medium 144. For example, in state 325, the device 140 sends a packet FILL_BUF(ID, ADDR, LEN, DATA) to the host 120 as the buffer fill request. The columns ID, ADDR, and LEN respectively specify the buffer ID of the target segment for storing the data, the offset of the target segment, and the length of the data to be stored. The column DATA stands for the data the device 140 sends to the host 120.

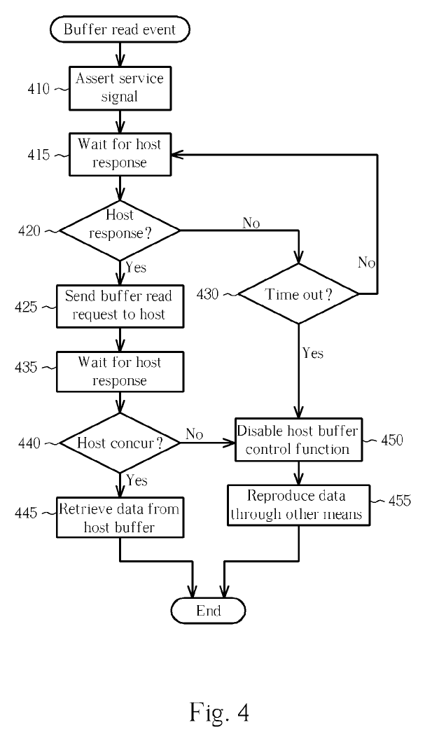

Assume that a buffer-read function of the device 140 is enabled. With the buffer-read function, the device 140 reads data from the external buffer provided by the host 120. The buffer ID of a target segment storing the data, the offset of the target segment, and the length of the data may be specified by the device 140. FIG. 4 shows an exemplary state chart of the device 140 performing the aforementioned buffer-read function. In the beginning, a buffer read event occurs. In response to the buffer read event, the device 140 asserts a service signal on the first interface 130 to request service from the host 120. If a timer expires before the host 120 responds to the asserted service signal, the device 140 simply disables its host buffer control function and reproduces the data through other means. However, if the host 120 responds to the asserted service signal before the timer expires, the device 140 sends a buffer read request to the host 120. The device 140 then waits for the host 120 to respond. If the host 120 concurs with the buffer read request, the host 120 retrieves the required data from the storage medium 121 according to the buffer read request issued by the device 140 and sends the retrieved data to the device 140. The state chart is then ended. If the host 120 does not respond to the buffer read request in time or simply rejects to the buffer read request, the device 140 disables its host buffer control function and reproduces the required data through other means. These means may include reading the mass information source 160 again to reproduce the required data. For example, in state 425, the device 140 sends a packet READ_BUF(ID, ADDR, LEN) to the host 120 as the buffer read request. In state 445, the host 120 retrieves the data from the storage medium 121 according to the packet READ_BUF and sends the retrieved data to the device 140. The columns ID, ADDR, LEN respectively specify the buffer ID of the target segment storing the data, the offset of the target segment, and the length of the data to be retrieved.

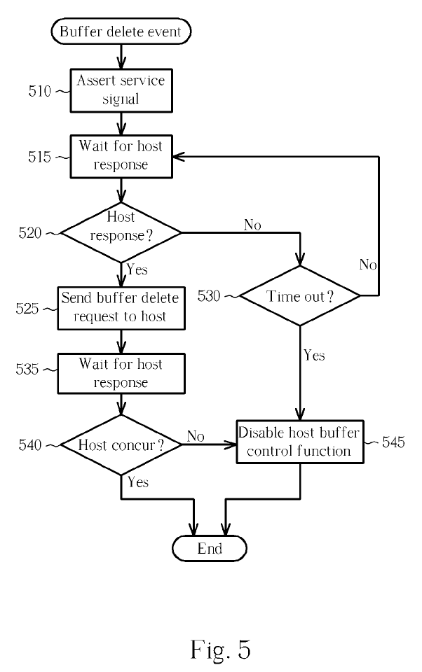

Assume that a buffer-delete function of the device 140 is enabled. With the buffer-delete function, the device 140 returns to the host 120 at least one segment of the storage medium 121, which the host 120 has previously allocated to the device 140. The device 140 may have to specify the buffer ID of the segment going to be returned. FIG. 5 shows an exemplary state chart of the device 140 performing the aforementioned buffer-delete function. In the beginning, a buffer delete event occurs. In response to the buffer delete event, the device 140 asserts a service signal on the first interface 130 to request service from the host 120. If a timer expires before the host 120 responds to the asserted service signal, the device 140 simply disables its host buffer control function and ends the state chart. If, on the other hand, the host 120 responds to the asserted service signal before the timer expires, the device 140 sends a buffer delete request to the host 120. For example, in state 525, the device 140 sends a packet DELETE_BUF(ID) to the host 120 as the buffer delete request. The column ID encompassed in the packet DELETE_BUF specifies the buffer ID of the external buffer going to be returned. The device 140 then waits the host 120 to respond. If the host 120 concurs with the buffer delete request, the host 120 simply disclaims the segment from the device 140. The device 140 is thereafter not allowed to use the returned buffer space as external buffer. If the host 120 does not response to the buffer delete request in time, the device 140 disables its host buffer control function and ends the state chart.

Assume that a buffer-copy function of the device 140 is enabled. With the buffer-copy function, the device 140 asks the host 120 to copy data. For example, the device 140 sends a packet COPY_BUF(ID1, ADDR1, LEN, ID2, ADDR2) to the host 120 as a buffer copy request. The columns ID1, ADDR1, LEN, ID2, and ADDR2 respectively specify the source buffer ID, the offset of the source buffer, the length of the data to be copied, the destination buffer ID, and the offset of the destination buffer. The host 120 then copies the data with length LEN and addresses indicated by the columns ID1 and ADDR1 to addresses indicated by the columns ID2 and ADDR2.

Assume that a buffer-set function of the device 140 is enabled. With the buffer-set set, the device 140 asks the host 120 to set the content of the allocated segment of the storage medium 121. For example, the device 140 sends a packet SET_BUF(ID, ADDR, LEN, PAT) to the host 120 as a buffer set request. The columns ID, ADDR, LEN, and PAT respectively specify the target buffer ID, the offset of the target buffer, the length of the data to be set, and the desired data pattern. The host 120 then sets the data with length LEN and addresses indicated by the columns ID and ADDR according to the desired data pattern PAT.

If the device 140 and the host 120 have agreement on one or more data processing functions, the device 140 is allowed to ask the host 120 to encode data stored in the allocated segment according to one of the agreed upon data processing functions. More specifically, assume that a buffer-encode function of the device 140 is enabled. With the buffer-encode function the device 140 sends a packet ENCODE_BUF(ID, ADDR, LEN, FUNC) to the host 120 as a buffer encode request, where a pre-defined encode function number (e.g. a number to be filled in the column FUNC) is typically provided in this embodiment, so the device 140 may utilize the pre-defined encode function number to represent the buffer-encode function rather than sending the buffer-encode function to the host 120 every time. According to this embodiment, the columns ID, ADDR, LEN, and FUNC respectively specify the target buffer ID, the offset of the target buffer, the length of the data to be processed, and the desired data processing function. The host 120 then uses a data processing function specified by the column FUNC to process the data with length LEN and addresses indicated by the columns ID and ADDR. After completing the operation corresponding to the buffer encode request, the host 120 typically sends a response (e.g. RETURN(OK) in this embodiment) to the device 140. With this buffer-process scenario, the computation power of the host 120 is shared to the device 140 and the burden of the device 140 is alleviated.

According to different implementation choices of this embodiment, the CPHB scheme may correspond to a “black box” or a “white box”. With the black box applied to the CPHB scheme, data in a CPHB cannot be operated directly by the host 120, where checksum or encryption may be helpful for implementation. This implementation choice is suitable for some copyright or encryption issues. With the white box applied to the CPHB scheme, both of the host 120 and the device 140 may access data in a CPHB, where the data is readable for both of the host 120 and the device 140. According to this implementation choice, the load of a computing operation can be shared by both of the host 120 and the device 140.

Furthermore, the host 120 and the device 140 can negotiate details of the CPHB scheme. For example, in an initialization phase of the electrical system 100, the host 120 is allowed to send a feature query request QUERY_FEA to the device 140 to ask whether the device 140 supports the CPHB function and what features the device 140 supports. In response to the feature query request QUERY_FEA, the device 140 sends a feature report packet RETURN(SFCDFRSCEV) to the host 120. The feature report packet RETURN(SFCDFRSCEV) of this example encompasses ten successive letters as feature flags. In the ten letters, the first S stands for the CPHB function; upper case means that the device 140 supports the CPHB function while lower case means that the device 140 does not support the CPHB function. In addition, the first F stands for the fixed-buffer function; the first C stands for the buffer-create function; the letter D stands for the buffer-delete function; the second F stands for the buffer-fill function; the letter R stands for the buffer-read function; the second S stands for the buffer-set function; the second C stands for the buffer-copy function; the letter E stands for the buffer-encode function; and the letter V is reserved for future use. In the last nine successive letters, an upper case means a corresponding function is enabled, and a lower case means a corresponding function is disabled. For example, if the device 140 sends a feature report packet RETURN(SfCDFRSCpV) to the host 120, the host 120 realizes that the fixed-buffer function and the buffer-process function are disabled, and other functions are all enabled.

In addition, the host 120 is allowed to send a feature set request SET_FEA(FCDFRSCPV) to the device 140. The device 140 then set its features according to the feature set request SET_FEA(FCDFRSCPV). The meaning of the nine successive letters included in the feature set request SET_FEA(FCDFRSCPV) is the same as that of the last nine successive letters included in the feature report packet RETURN(SFCDFRSCPV). In the nine successive letters of the feature set request SET_FEA(FCDFRSCPV), an upper case means that the host 120 commands the device 140 to enable a corresponding function, and a lower case means that the host 120 commands the device 140 to disable a corresponding function. More specifically, through the first to third letters, the host 120 allows the device 140 to use fixedly allocated external buffers or borrow external buffers dynamically. Through the fourth to eighth letters, the host 120 enable/disable the device 140 to utilize external buffers provided by the host 120. In addition, when the first F is capitalized, the host 120 may also specify a buffer ID and a buffer size of a fixedly allocated external buffer in the feature set request.

The buffer-create function, the buffer-delete function, the buffer-fill function, the buffer-read function, the buffer-set function, the buffer-copy function, and the buffer-encode function are referred to as CPHB default functions. A function enable command ENABLE_CPHB allows the host 120 to enable all the CPHB default functions at once. After the function enable command ENABLE_CPHB is issued, all the CPHB default functions become usable. On the contrary, a function disable command DISABLE_CPHB allows the host 120 to disable all the CPHB default functions at once. After the function disable command DISABLE_CPHB is issued, all the CPHB default functions are banned from being used.

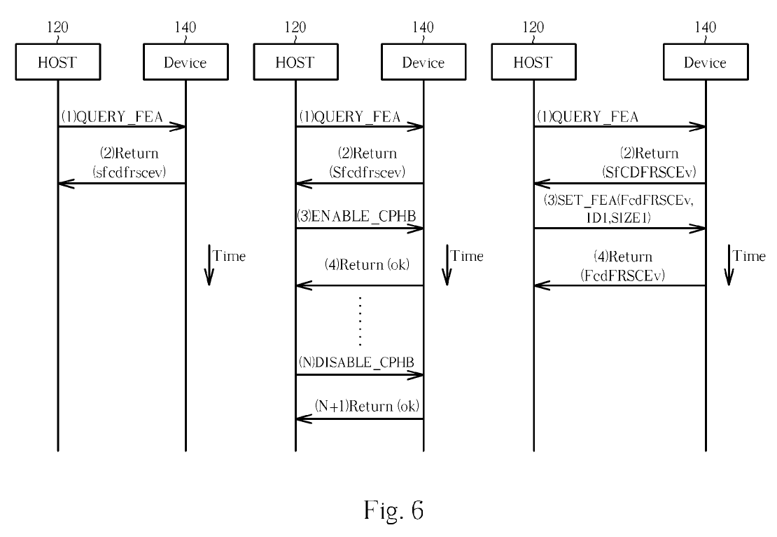

FIG. 6 shows three examples of interaction flow between the host 120 and the device 140. In the left-hand-side example of FIG. 6, the host 120 first sends a feature query request QUERY_FEA to the device 140. Then the device 140 sends a feature report packet RETURN(sfcdfrscev) to the host 120. Since the first letter s is in lower case, the host 120 comprehends that the device 140 does not support the CPHB function. Therefore, no further CPHB related operations would be performed subsequently.

In the center example of FIG. 6, the host 120 first sends a feature query request QUERY_FEA to the device 140. Then the device 140 sends a feature report packet RETURN(Sfcdfrscev) to the host 120. Since the first letter S is capitalized, the host 120 comprehends that the device 140 do support the CPHB function. However, all the CPHB default functions are disabled. The host 120 therefore sends a function enable command ENABLE_CPHB to the device 140 to enable all the CPHB default functions at once. After the function enable command ENABLE_CPHB is concurred by the device 140, CPHB related operations can be performed by the electrical system 100. At the end of this scenario, the CPHB default functions are no further required, the host 120 simply sends a function disable command DISABLE_CPHB to the device 140 to disable all the CPHB default functions and waits the device 140 to response.

In the right-hand-side example of FIG. 6, the host 120 first sends a feature query request QUERY_FEA to the device 140. Then the device 140 sends a feature report packet RETURN(SfCDFRSCEv) to the host 120. Next, the host 120 sends a feature set command SET_FEA(FcdFRSCEv, ID1, SIZE1) to the device 140. The feature set command SET_FEA(FcdFRSCEv, ID1, SIZE1) changes the state of the fixed-buffer function from disabled to enabled. Besides, the originally enabled buffer-create function and buffer-delete function are disabled by the feature set command SET_FEA(FcdFRSCEv, ID1, SIZE1). The columns ID1 and SIZE1 respectively specify the fixed buffer ID and the fixed buffer size provided by the host 120. After the feature set command SET_FEA(FcdFRSCPv, ID1, SIZE1) is concurred by the device 140, the device 140 can start utilizing the buffer-fill function, the buffer-read function, the buffer-set function, the buffer-copy function, and the buffer-encode function.

In practice, a segment of the storage medium 121 being allocated to the device 140 as an external buffer can be a so called “black box” or a “white box” to the host 120. If a segment of the storage medium 121 allocated to the device 140 is a black box to the host 120, only the device 140 has authority on the data stored in the segment. The host 120 cannot operate the data stored in the segment directly. Checksums and/or encryption may be required to protect the data stored in the segment. This black box scheme is suitable for some copyright or encryption issues for example.

On the other hand, if a segment of the storage medium 121 allocated to the device 140 is a white box to the host 120, both the device 140 and the host 120 have authority on the data stored in the segment. Computation can therefore be shared between the host 120 and the device 140. Since the computational ability of the host 120 is greater than that of the device 140, letting the host 120 to share the computation burden greatly improves the performance of the electrical system 100.

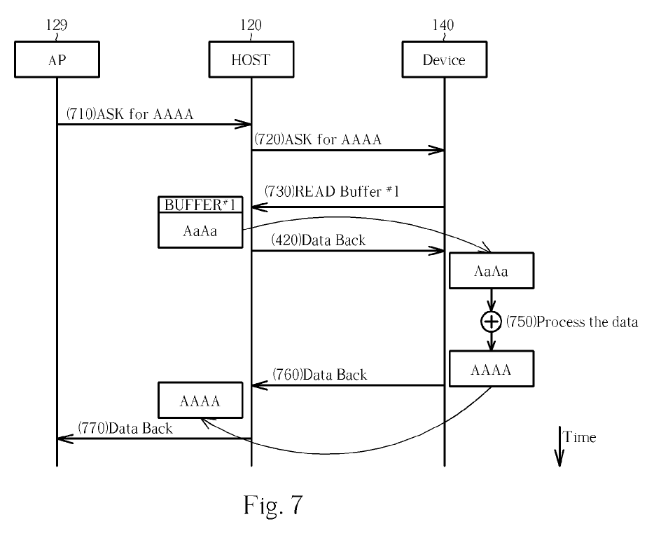

In the related art, if a data section of the mass information source 160 is required many times by the host 120, the device 140 has to reproduce the data section by performing read operations on the mass information source 160 many times. Each time the device 140 performs read operations on the mass information source 160 to reproduce the data section, a great amount of time is wasted since the second interface 146 is relatively slow. On the contrary, with the ideas proposed by this disclosure, the device 140 can utilize the external buffers provided by the host 120 to store the frequently used data section. The device 140 has only to perform read operations on the mass information source 160 once to reproduce the data section. The data section is then stored in the external buffer quasi-permanently. Later, the data section can be directly used many times by the host 120 and the device 140 without requiring the device 140 to perform read operations on the mass information source 160. FIG. 7 shows an example of interaction flow between an application program (AP) 129, the host 120, and the device 140. The AP 129 is executed on the host 120 but is not shown in FIG. 1. In step 710, the AP 129 asks the host 120 to return data. In step 720, the host 120 asks the device 140 to return the required data. In this example, the device 140 finds that the required data is already fetched from the mass information source 160 and pre-stored in an external buffer indicated by ID1. Since the data needs to be post-processed by the device 140 itself, the device 140 reads the data from the external buffer (steps 730 and 740) and processes on the data (step 750). In step 760, the device 140 sends the post-processed data to the host 120. The host then sends the post-processed data to the AP 129 (step 770).

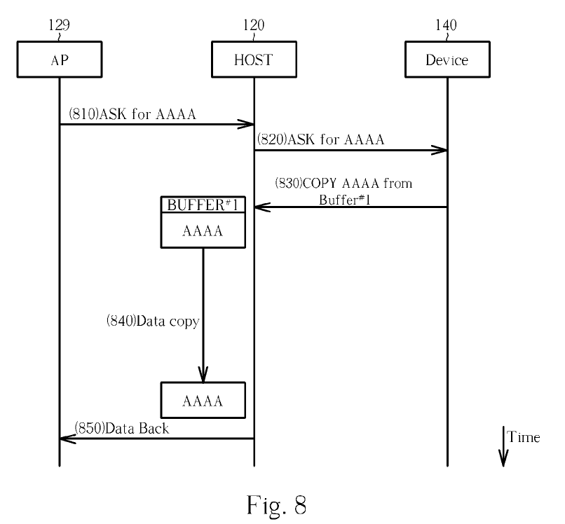

FIG. 8 shows another example of interaction flow between the AP 129, the host 120, and the device 140. In step 810, the AP 129 asks the host 120 to return data. In step 820, the host 120 asks the device 140 to return the required data. In this example, the device 140 finds that the required data is already fetched from the mass information source 160 and pre-stored in an external buffer indicated by ID1. Since no post-process is needed, the device 140 simply tells the host 120 where the require data is stored in the external buffer. The host 120 then sends the pre-stored data to the AP 129.

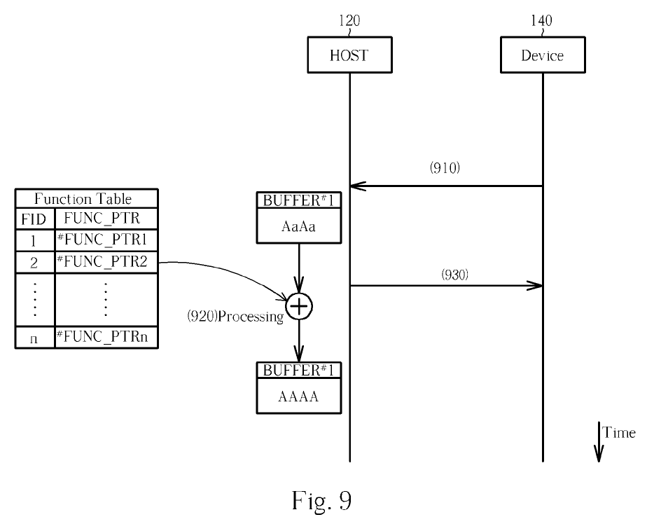

FIG. 9 shows an example of interaction flow between the host 120 and the device 140. In step 910, the device 140 asks the host 120 to use a function, which is indicated by a function indicator FID2, to process data stored in an external buffer, which is indicated by ID1. The host 120 then looks up a mutually agreed function table to find which function FID2 corresponds to. In step 920, the host utilized the very function to process the data. Finally, the host reports the process result to the device 140 in step 930.

The CPHB schemes let many different applications to become feasile. For example, power saving on the device 140 can be achieved. The number of times the device 140 accesses the mass information source 160 is reduced. Additionally, power down of the storage medium 144 is feasible. Power consumption of the device 140 is therefore reduced. Furthermore, for some optical disc types, they have defect areas and it takes time to read these defected sectors out, the device can perform the read operation and save these mass information in the host buffer. The number of times of performing read operations on the defect sectors is thereby limited to one. In this way, the defect sections on the mass information source that typically cause tremendous reading time to be wasted will not hamper the performance of the electrical system 100.

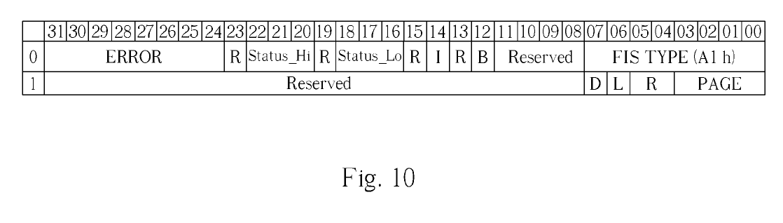

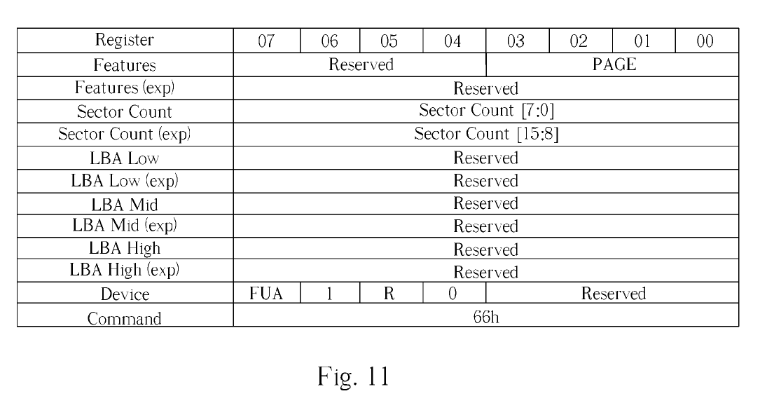

Some CPHB-related protocol specifications are disclosed herein. Regarding a first protocol provided according to an embodiment of the present invention, field definitions of a frame information structure (FIS) are described as follows. As shown in FIG. 10, at least one portion of some originally reserved fields corresponding to a FIS type of A1h (which is labeled as “FIS TYPE (A1 h)” in FIG. 10) is utilized for CPHB control regarding the first protocol in this embodiment, where there are two Double Words (DWords) in the FIS when the value of the field “FIS TYPE” is set as A1h. According to this embodiment, the operation code for an ATA READ CPHB command is 66h as shown in FIG. 11, where some originally reserved fields are utilized for CPHB control, for example, the fields PAGE, “Sector Count [7:0]”, and “Sector Count [15:8]”.

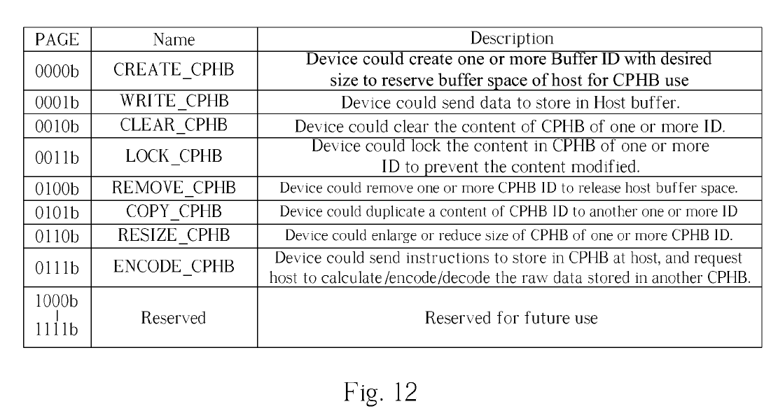

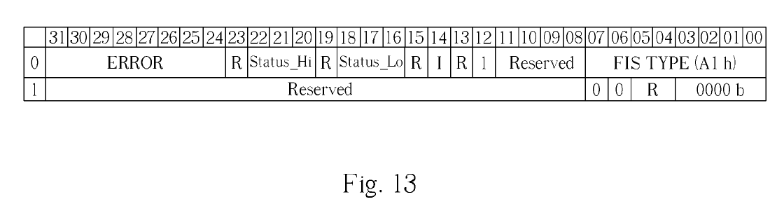

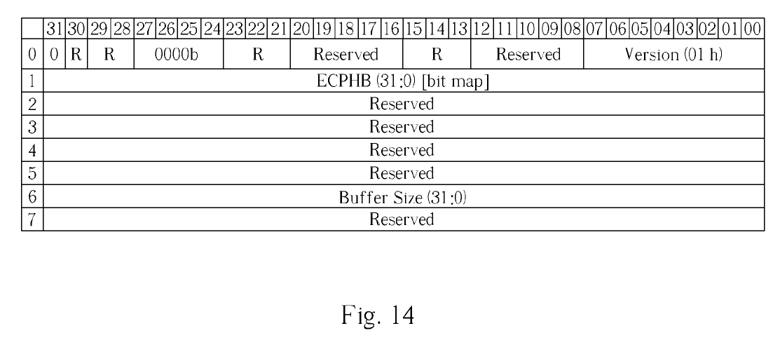

In addition, the field “B” at bit 12 of DWord 0 shown in FIG. 10 is a CPHB control bit for controlling or indicating whether a buffer of the host (e.g. one of the external buffers mentioned above) is controlled by the device, and the field PAGE at the end of DWord 1 shown in FIG. 10 represents one of a plurality of function modes of CPHB as shown in FIG. 12, where the field PAGE is valid when the field “B” is asserted. Additionally, the field “L” is utilized for listing control corresponding to a CPHB ID, where the field “L” is valid when the field “B” is asserted. For example, if the value of the field “L” is equal to 1, it means listing all statuses in detail (for example, information such as ERROR and Buffer Size). Conversely, if the value of the field “L” is equal to 0, it means listing the header only. Additionally, the field “D” contains the information of whether or how subsequent data is transferred, where the field “D” is valid when the field “B” is asserted. For example, if the field “D” is equal to 1, it means the subsequent data is transferred from the host to the device. Conversely, if the field “D” is equal to 0, it means the subsequent data is transferred from the device to the host. Taking the function mode CREATE_CPHB shown in FIG. 12 as an example, the corresponding FIS format is illustrated as shown in FIG. 13, and the corresponding format of response data is illustrated as shown in FIG. 14. According to this embodiment, the value of the field “B” shown in FIG. 13 (i.e. bit 12 of DWord 0) is 1, the value of the field PAGE shown in FIG. 13 (i.e. bits 03-00 of DWord 1) is 0000b corresponding to the function mode CREATE_CPHB, the value of the field “L” shown in FIG. 13 (i.e. bit 06 of DWord 1) is 0, and the value of the field “D” shown in FIG. 13 (i.e. bit 07 of DWord 1) is 0.

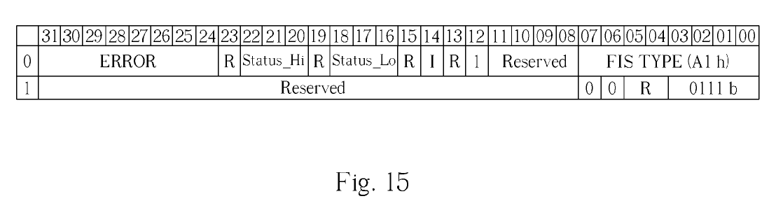

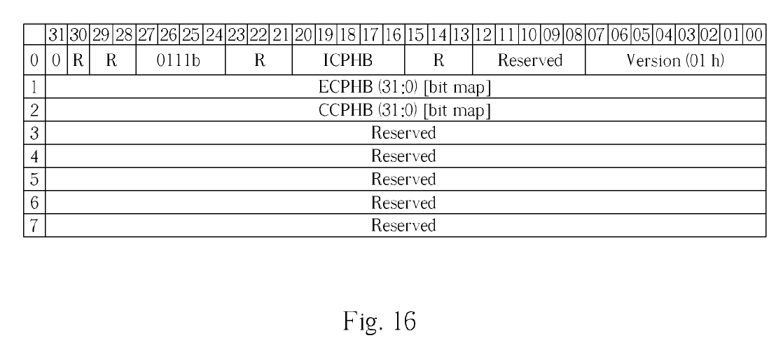

Taking the function mode ENCODE_CPHB shown in FIG. 12 as another example, the corresponding FIS format is illustrated as shown in FIG. 15, and the corresponding format of response data is illustrated as shown in FIG. 16. According to this embodiment, the value of the field “B” shown in FIG. 15 (i.e. bit 12 of DWord 0) is 1, the value of the field PAGE shown in FIG. 15 (i.e. bits 03-00 of DWord 1) is 0111b corresponding to the function mode ENCODE_CPHB, the value of the field “L” shown in FIG. 15 (i.e. bit 06 of DWord 1) is 0, and the value of the field “D” shown in FIG. 15 (i.e. bit 07 of DWord 1) is 0.

Please note that at least two cases are involved here. In a first case, when the device wants to cook more than one set of raw data via the function mode ENCODE_CPHB, the cooked data must be restored to the same position which is the homologous raw-data-in. It means COOKED_CPHB (31:0) shall be the same as ECPHB (31:0). In a second case, when the device wants to cook only one set of raw data via the function mode ENCODE_CPHB, the cooked data could be stored anywhere besides the locked CPHB.

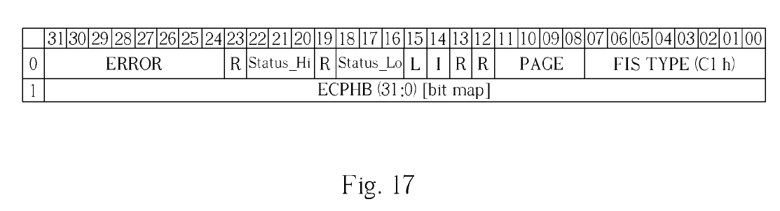

FIG. 17 illustrates field definitions of a FIS regarding a second protocol provided according to another embodiment of the present invention, where a newly disclosed FIS type of C1h (which is labeled as “FIS TYPE (C1 h)” in FIG. 17) is utilized for CPHB control regarding the second protocol in this embodiment. As shown in FIG. 17, there are two DWords in the FIS when the value of the field “FIS TYPE” is set as C1h.

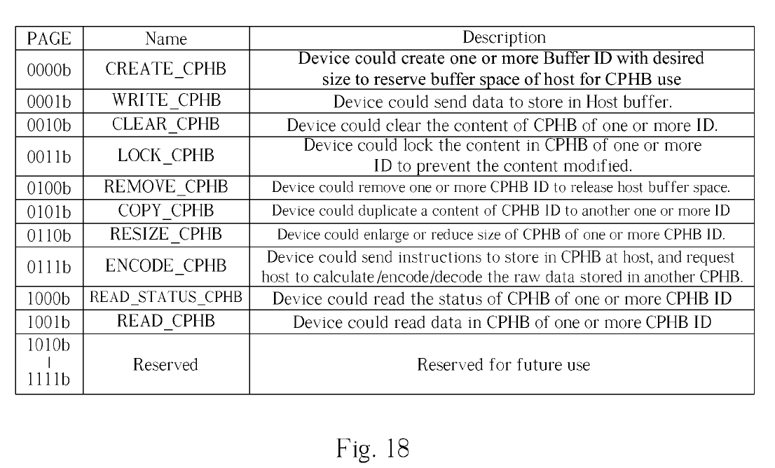

According to this embodiment, the field PAGE at bits 11-08 of DWord 0 shown in FIG. 17 represents one of a plurality of function modes of CPHB as shown in FIG. 18. In addition, the field “I” (i.e. bit 14 of DWord 0) is an interrupt bit that can be utilized for controlling an host adapter (e.g. the interface 130) to enter an interrupt pending state if both of a BSY bit and a DRQ bit in a shadow status register are zero when a frame is received, and the field “L” (i.e. bit 15 of DWord 0) is similar to that shown in FIG. 10.

Additionally in this embodiment, the field ERROR (i.e. bits 31-24 of DWord 0) is defined to contain a new value of an error register of a shadow register block, the field Status-Hi is defined to contain a new value of bits 6-4 of the status register of the shadow register block, the field Status-Lo is defined to contain a new value of bits 2-0 of the status register of the shadow register block, the fields “R” are reserved fields, and the field ECPHB (which stands for “Expect CPHB”) in the CPHB FIS here can be utilized for communicating expectancy notification for each of up to 32 buffer IDs, where the field ECPHB is bit-significant, and the device may set more than one bit to this field.

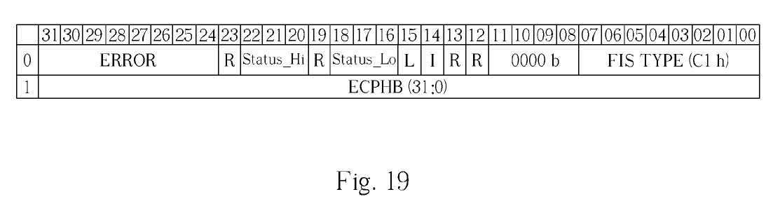

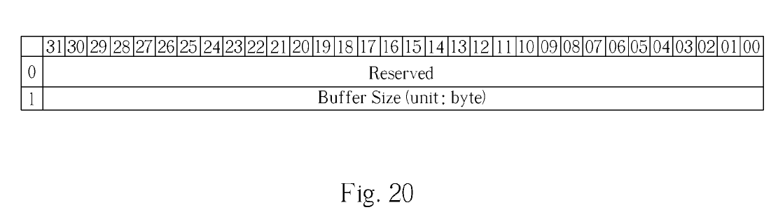

Taking the function mode CREATE_CPHB shown in FIG. 18 as an example, the corresponding FIS format is illustrated as shown in FIG. 19, and the corresponding sending format via data FIS is illustrated as shown in FIG. 20. According to this embodiment, the value of the field PAGE shown in FIG. 19 (i.e. bits 11-08 of DWord 0) is 0000b corresponding to the function mode CREATE_CPHB. The device issues the function mode CREAT_CPHB, PIO setup FIS (which is from the device to the host), and the data FIS for assigning the buffer size (by utilizing the field “Buffer Size”). The HOST has no need to respond here. In addition, the device could get the result by utilizing the function mode READ_STATUS_CPHB shown in FIG. 18.

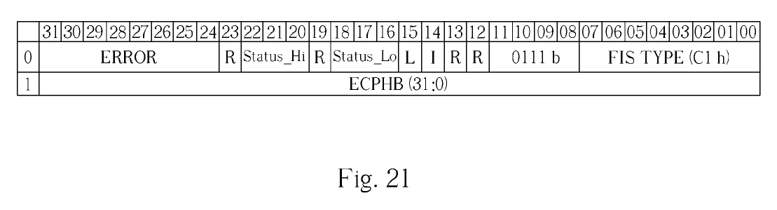

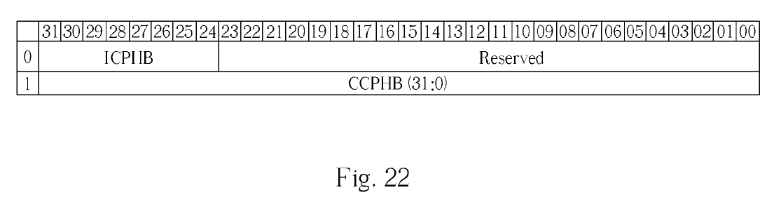

Taking the function mode ENCODE_CPHB shown in FIG. 18 as another example, the corresponding FIS format is illustrated as shown in FIG. 21, and the corresponding sending format via data FIS is illustrated as shown in FIG. 22. According to this embodiment, the value of the field PAGE shown in FIG. 21 (i.e. bits 11-08 of DWord 0) is 0111b corresponding to the function mode ENCODE_CPHB, and the field ECPHB at DWord 1 shown in FIG. 21 can be utilized for communicating raw-data-in notification for each of up to 32 buffer IDs, where the field ECPHB is bit-significant, and the device may set one bit or more than one bit to this field. In addition, the field ICPHB (which stands for “Instruction CPHB”) shown in FIG. 22 (i.e. bits 31-24 of DWord 0) can be utilized for communicating the position of instructions, where this field is byte-significant, and the device may set one and only one CPHB ID. Additionally, the field CCPHB (which stands for “Cooked CPHB”) at DWord 1 shown in FIG. 22 can be utilized for communicating and assigning the position where the cooked data should be stored, where this field is bit-significant, and the device may set more than one bit to this field.

Those skilled in the art will readily observe that numerous modifications and alterations of the device and method may be made while retaining the teachings of the invention. For example, in some embodiments, the buffer-related requests such as buffer-create, buffer-delete, buffer-copy, and buffer-set, should not be limited to being applied to one destination ID, and can also be applied to a plurality of destination IDs. Accordingly, the above disclosure should be construed as limited only by the metes and bounds of the appended claims.

What is claimed is:

1. A method utilized in an electrical system comprising a device, a host having a storage medium, and an interface interconnecting the device and the host; the method comprising:
the device sending a buffer-related request to the host, the buffer-related request corresponding to a segment of the storage medium; and
the host performing processing related to the segment of the storage medium according to the buffer-related request;
wherein the segment of the storage medium is allocated to the device as an external buffer.

2. The method of claim 1, wherein the step of the device sending the buffer-related request to the host further comprises:
the device sending a buffer create request as the buffer-related request to the host;
wherein the step of the host performing processing related to the segment of the storage medium according to the buffer-related request further comprises:
the host allocating the segment of the storage medium to the device;
wherein the method further comprises:
the device utilizing the segment as the external buffer.

3. The method of claim 2, wherein the step of the device sending the buffer create request to the host comprises:
the device specifying a required buffer size in the buffer create request.

4. The method of claim 2, wherein the step of the host allocating the segment of the storage medium to the device comprises:
the host returning a buffer identity (ID) to the device, the returned buffer ID corresponding the allocated segment.

5. The method of claim 1, wherein the step of the device sending the buffer-related request to the host further comprises:
the device sending a buffer fill request as the buffer-related request to the host and sending data to the host;
wherein the step of the host performing processing related to the segment of the storage medium according to the buffer-related request further comprises:
the host storing the data into the segment according to the buffer fill request.

6. The method of claim 5, wherein the step of the device sending the buffer fill request to the host comprises:
the device specifying a buffer ID corresponding to the segment, an offset of the segment, and a length of the data in the buffer fill request.

7. The method of claim 1, wherein the step of the device sending the buffer-related request to the host further comprises:
the device sending a buffer read request as the buffer-related request to the host;
wherein the step of the host performing processing related to the segment of the storage medium according to the buffer-related request further comprises:
the host retrieving data from the segment according to the buffer read request and sending the retrieved data to the device.

8. The method of claim 7, wherein the step of the device sending the buffer read request to the host comprises:
the device specifying a buffer ID corresponding to the segment, an offset of the segment, and a length of the data in the buffer read request.

9. The method of claim 1, wherein the step of the device sending the buffer-related request to the host further comprises:
the device sending a buffer delete request as the buffer-related request to the host;
wherein the step of the host performing processing related to the segment of the storage medium according to the buffer-related request further comprises:
the host disclaiming the segment from the device;
wherein the method further comprises:
the device stopping utilizing the segment as the external buffer.

10. The method of claim 9, wherein the step of the device sending the buffer delete request to the host comprises:
the device specifying a buffer ID corresponding to the segment in the buffer delete request.

11. The method of claim 1, wherein the step of the device sending the buffer-related request to the host further comprises:
the device sending a buffer set request as the buffer-related request to the host;
wherein the step of the host performing processing related to the segment of the storage medium according to the buffer-related request further comprises:
the host setting data in the segment according to the buffer set request.

12. The method of claim 11, wherein the step of the device sending the buffer set request to the host comprises:
the device specifying a buffer ID corresponding to the segment, an offset of the segment, a length of the data, and a desired data pattern in the buffer set request.

13. The method of claim 12, wherein the step of the host setting the data in the segment according to the buffer set request comprises:
the host setting the data indicated by the buffer ID, the offset, and the length according to the desired data pattern.

14. The method of claim 1, wherein the step of the device sending the buffer-related request to the host further comprises:
the device sending a buffer encode request as the buffer-related request to the host;
wherein the step of the host performing processing related to the segment of the storage medium according to the buffer-related request further comprises:
the host processing data in the segment according to the buffer encode request.

15. The method of claim 14, wherein the step of the device sending the buffer encode request to the host comprises:
the device specifying a buffer ID corresponding to the segment, an offset of the segment, a length of the data, and a desired data processing function in the buffer encode request.

16. The method of claim 15, wherein the step of the host processing the data in the segment according to the buffer encode request comprises:
the host utilizing the desired data processing function to encode the data indicated by the buffer ID, the offset, and the length.

17. The method of claim 1, wherein at least one segment of the storage medium is allocated to the device as at least one external buffer(s), and the step of the device sending the buffer-related request to the host further comprises:
the device sending a buffer copy request as the buffer-related request to the host;
wherein the step of the host performing processing related to the segment of the storage medium according to the buffer-related request further comprises:
the host copying data from a source buffer among the external buffer(s) to a destination buffer among the external buffer(s) according to the buffer copy request.

18. The method of claim 17, wherein the step of the device sending the buffer copy request to the host comprises:
the device specifying a source buffer ID, a source buffer offset, a length of the data, a destination buffer ID, and a destination buffer offset in the buffer copy request.

19. A method utilized in an electrical system comprising a device, a host comprising a storage medium, and an interface interconnecting the device and the host; the method comprising:
the host sending a common purpose host buffer-related (CPHB-related) command to the device; and
the device performing processing according to the CPHB-related command.

20. The method of claim 19, wherein the step of the host sending the CPHB-related command to the device further comprises:
the host sending a feature query command as the CPHB-related command to the device;
wherein the step of the device performing processing according to the CPHB-related command further comprises:
the device sending a feature report packet to the host to at least report whether the device supports a CPHB function.

21. The method of claim 20, wherein the step of the device performing processing according to the CPHB-related command further comprises:
the device utilizing the feature report packet to report whether a fixed-buffer function is enabled, whether a buffer-create function is enabled, whether a buffer-delete function is enabled, whether a buffer-fill function is enabled, whether a buffer-read function is enabled, whether a buffer-set function is enabled, whether a buffer copy-function is enabled, or whether a buffer-process function is enabled.

22. The method of claim 19, wherein the step of the host sending the CPHB-related command to the device further comprises:
the host sending a feature set command as the CPHB-related command to the device to enable/disable a fixed-buffer function, a buffer-create function, a buffer-delete function, a buffer-fill function, a buffer-read function, a buffer-set function, a buffer-copy function, or a buffer-process function of the device;
wherein the step of the device performing processing according to the CPHB-related command further comprises:
the device setting its features according to the feature set command.

23. The method of claim 19, wherein the step of the host sending the CPHB-related command to the device further comprises:
the host sending a function enable command as the CPHB-related command to the device to enable CPHB default functions of the device;
wherein the step of the device performing processing according to the CPHB-related command further comprises:
the device setting its features according to the function enable command.

24. The method of claim 23, wherein the CPHB defaults functions comprise a buffer-create function, a buffer-delete function, a buffer-fill function, a buffer-read function, a buffer-set function, a buffer-copy function, or a buffer-process function.

25. The method of claim 19, wherein the step of the host sending the CPHB-related command to the device further comprises:
the host sending a function disable command as the CPHB-related command to the device to disable CPHB default functions of the device;
wherein the step of the device performing processing according to the CPHB-related command further comprises:
the device setting its features according to the function disable command.

26. The method of claim 25, wherein the CPHB default functions comprise a buffer create function, a buffer delete function, a buffer fill function, a buffer read function, a buffer set function, a buffer copy function, or a buffer process function.

27. An electrical system comprising:
a mass information source;
a device including a second interface, the second interface allowing the device to access the mass information source;
a host including a storage medium; and
a first interface interconnecting the host and the device;
wherein the device is for assisting the host to access the mass information source, and a segment of the storage medium of the host is allocated to the device as an external buffer.

28. The electrical system of claim 27, wherein the first interface allows the device to send requests to the host voluntarily.

29. The electrical system of claim 28, wherein the host is for managing the segment of the storage medium according to the requests received from the device.
